(19) United States
(12) Patent Application Publication
(10) Pub. No.: US 2002/0177113 A1
(43) Pub. Date: Nov. 28, 2002

(54) Method and apparatus for learning to play musical instruments

(76) Inventor: Thomas Mallory Sherlock, Los Altos Hills, CA (US)

Correspondence Address: DOUGLAS M. CLARKSON, 1720 Fireside Place, Alpharetta, GA, 30004, US

(21) Appl. No.: 10/150,093

(22) Filed: Aug. 7, 2002

Related U.S. Application Data
(63) Continuation of application No. 09/593,598, filed on Jun. 12, 2000.

(51) Int. Cl. G09B 5/00

(52) U.S. Cl. 434/308

(57) ABSTRACT

A method and apparatus for training users to play musical instruments which provides anticipation of notes to be played and the initiation time of a note as well as its duration, while not requiring the ability to read music. The apparatus provides a plurality of light emitting elements arranged and activated in sequence.

### FIELD OF THE INVENTION

The present invention, generally, relates to a new and improved technique, involving method and apparatus, by which a person can learn to play various musical instruments and, more particularly, can learn to play without first having to learn to read music.

### BACKGROUND OF THE INVENTION

The process of learning to play a musical instrument the traditional way is tedious and time consuming. It first requires learning to read music and much practice, and if it is undertaken seriously, it requires learning the notes, training the ear to know the tempo of music, developing muscle memory and understanding the effect of these on hearing.

Teachers usually are required to inspire practice and to show and to demonstrate correct techniques, which increases the expense of learning music and which has resulted in music being dropped from the curriculum in many public schools. Learning music the traditional way is frustrating because a student must first learn to read notes and to play overly-simple pieces, which is boring.

A wide variety of teaching aids for musical instruments have been known for some time. These include a class of devices that use a single light for each note in teaching keyed as well as stringed musical instruments.

With such prior devices, the light blinks first to alert the student to an impending note to be played, and a short time later, the light stays ON to indicate “when” the note is to be played. Of course, the amount of advance warning is limited to the next note.

U.S. Pat. No. 5,746,605 to Kennedy granted May 5, 1998 describes a method that requires the structure of the musical work to be divided into variations with specific features in each.

U.S. Pat. No. 5,739,457 to Devecka granted Apr. 14, 1998 describes an interactive audio-visual apparatus for drums with no anticipation of future notes.

U.S. Pat. No. 5,690,496 to Kennedy granted Nov. 25, 1997 describes an anticipation feature that involves highlighting a portion of a music page for a student to follow.

U.S. Pat. No. 5,585,583 to Owen granted Dec. 17, 1996 describes apparatus that highlights a particular note already being played by a student without future notes.

U.S. Pat. No. 5,408,914 to Breitweiser, Jr. et al. granted Apr. 25, 1995 describes a specific stringed apparatus with lights to show where fingers are placed to play the music.

U.S. Pat. No. 4,694,723 to Shinohara et al. granted Sep. 22, 1987 describes a keyboard device to compare notes played with correct notes for a musical piece to rate a performance.

One element missing from these prior art devices is a feature that permits a user to anticipate notes to be played. The present invention permits a user to anticipate both the duration and the initiation time for each note without first having to learn to read music the conventional way.

The present invention provides such a teaching apparatus but makes using it a pleasure, while achieving the desired musical training. Several other and different desirable benefits can be realized from the use of the technique of the present invention, as will become more apparent as the description proceeds.

### OBJECTS AND SUMMARY OF THE INVENTION

Accordingly, it is a principal object of the present invention to provide a new and improved apparatus and method by which one can learn to play various musical instruments. Another object of the present invention is to provide a method and an apparatus to enable a person to play musical instruments prior to it becoming necessary to read music.

Yet another object of the present invention is to provide a technique by which a person can learn to play musical instruments without first having to learn other aspects of music, such as tempo, key signature and fingering.

A further object of the present invention is to provide a method and apparatus to enable a person to anticipate notes to be played.

Another object of the present invention is to provide a method and apparatus that signifies which finger is to be used to play each musical note.

A further object of the present invention is to provide a method and apparatus for providing options within a musical piece from which a person may make creative choices.

Briefly, a technique in accordance with the present invention provides a plurality of lights in predetermined arrays relative to each key or string of a musical instrument. The plurality of lights are connected to be energized in a predetermined sequence. It is this sequence that leads a user to respond and to actually play the musical instrument. It also permits anticipation of notes to be played, and it indicates duration of notes being played.

### BRIEF DESCRIPTION OF THE DRAWINGS

FIG. 1 is a circuit in block form illustrating a connection of components according to the invention.

FIG. 2 is a view of a monitor to display features to control the apparatus of the invention.

FIG. 3 is a view of a panel for selecting various operating characteristics in controlling the apparatus of the invention.

FIG. 4 illustrates the apparatus of the invention and the relationship between the apparatus of the invention and the keys of a piano.

FIG. 5 illustrates a modification of the apparatus of the present invention to achieve a different purpose of the invention.

FIG. 6 is a modification of the apparatus of the invention to operate with a different musical instrument.

FIG. 7 illustrates another modification of the apparatus of the invention for operation with still another musical instrument.

FIG. 8 illustrates another modification of the apparatus of the present invention to operate with yet a different musical instrument.

### DETAILED DESCRIPTION OF THE INVENTION

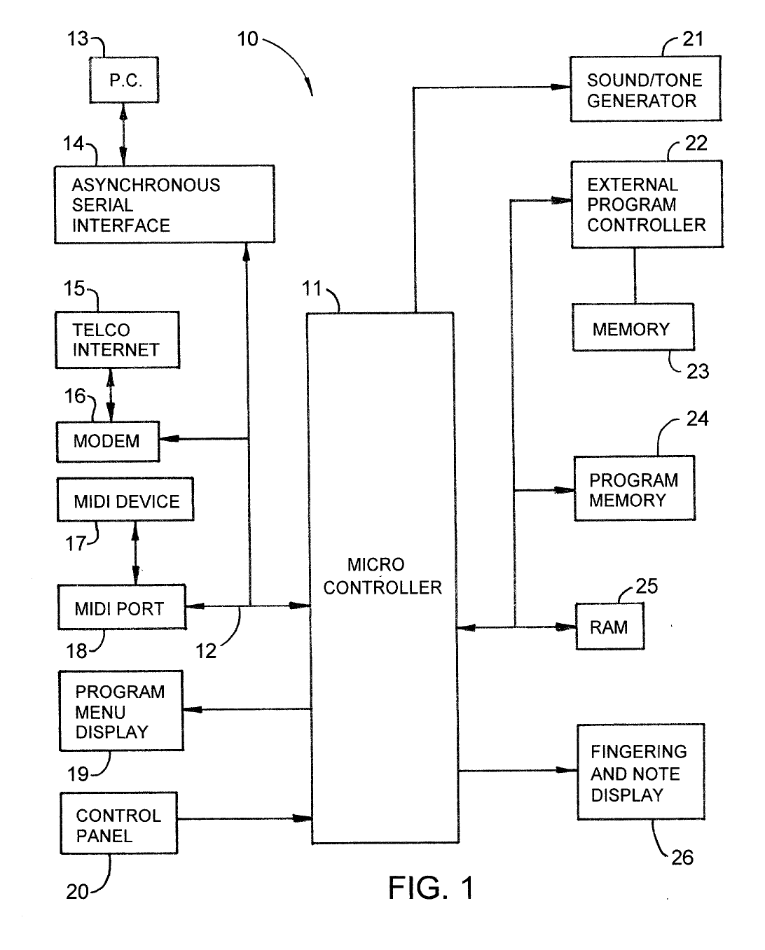

Referring first to FIG.1 of the drawings, various components are illustrated interconnected to obtain the advantages that the present invention makes available. For example, the block diagram 10 shows components with a micro controller 11 connected to receive input from selected sources.

A suitable micro controller is the Microchip Technology, Inc. PIC16C924 or the Microchip Technology, Inc. PIC17C756.

An input connection 12 provides input to the micro controller 11 from such sources as a personal computer 13 through an interface 14 or from the Internet 15 through a modem 16 or from a MIDI device 17 through an appropriate MIDI port 18.

A selected musical exercise is input to the apparatus of the invention from PC 13, the Internet 15, or a MIDI device 17 and is converted to direct play data, i.e., a key activation sequence, by micro controller 11. Direct play data is presented to the user on a fingering and note display 26.

The MIDI is an abbreviation for the industry standard “musical instrument digital interface”, and the MIDI “port” 18 is a specific port for interfacing the selected component as an input, like a “game port” for joysticks or a “parallel port” for interfacing with a printer.

Similarly, the asynchronous serial interface 14 through which the P.C. 13 connects with the micro controller 11, can be an asynchronous serial interface, or a “serial port”, used to connect computer peripherals. Any one, or more, of these inputs can be selected, in accordance with the present invention, as will become clearer hereafter.

A program menu display 19 shows a list of choices from which the user can select a particular function for the apparatus of the invention to operate in a manner to be described in more detail hereinafter.

A control panel 20 allows the user to select from program menu display 19 and to control the apparatus of the present invention. A sound/tone generator 21 is connected to the micro controller 11 and produces audio prompts, such as metronome beats, during a session on a musical instrument.

Continuing with a description of the components identified in the drawings, as illustrated in FIG. 1, an external program controller 22 has a memory 23 that is separate, or it can be combined with another device. Suitable external memory devices 23 include, but are not limited to, a floppy disc, a magnetic card, or a flash memory commonly found in personal computers.

A program memory 24 is connected to the micro controller 11, and a Random Access Memory (RAM) 25 is connected similarly. A fingering and note display 26 is connected to the micro controller 11 also, for use as a part of the present invention.

The micro controller 11 provides control of the system, and it has the capability to receive program from a variety of sources. Program sources include a floppy disc, a magnetic card, or a flash memory card via external program controller 22, a personal computer via asynchronous serial interface 14, or from a direct telephone connection to the internet via modem 16.

Music represented as a musical score is converted off-line to MIDI format data by a person skilled at reading music. Alternatively, music can be composed and recorded directly in the MIDI format. The micro controller 11 translates incoming data in MIDI format to direct play data used to drive the fingering and note display 26.

When the fingering and note display 26 is activated sequentially as a plurality of individual lights 35, the software program used can be similar to that used today in sequential moving display signs, and with the benefit of the present invention as described herein, it can be expected that many will enjoy the many benefits derived from being able to play musical instruments.

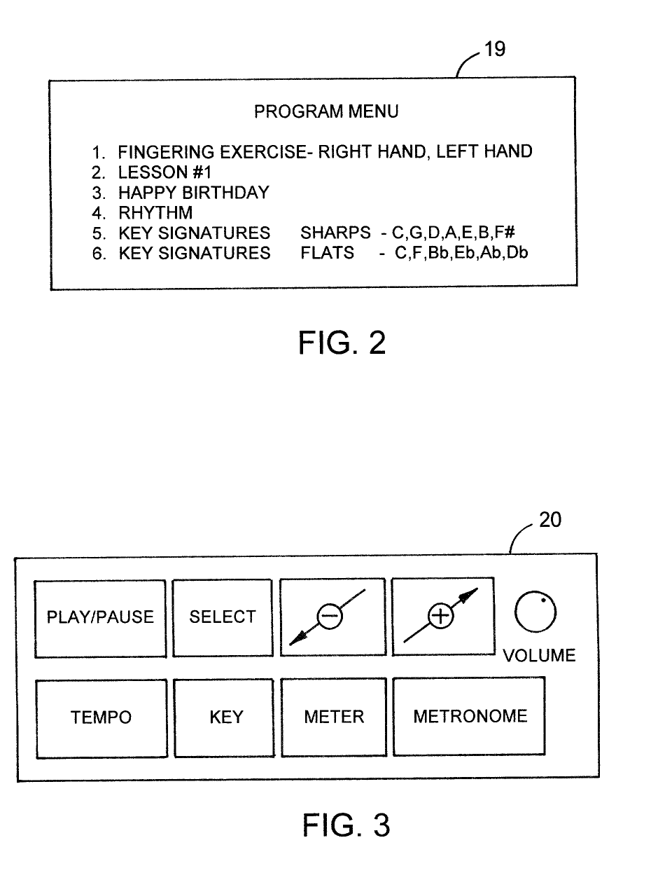

FIG. 2 of the drawings illustrates one form of the program menu display 19. FIG. 3 illustrates one form of the control panel 20. The particular programs illustrated by the menu 19 are readily changeable, as are the particular control functions illustrated by control panel 20.

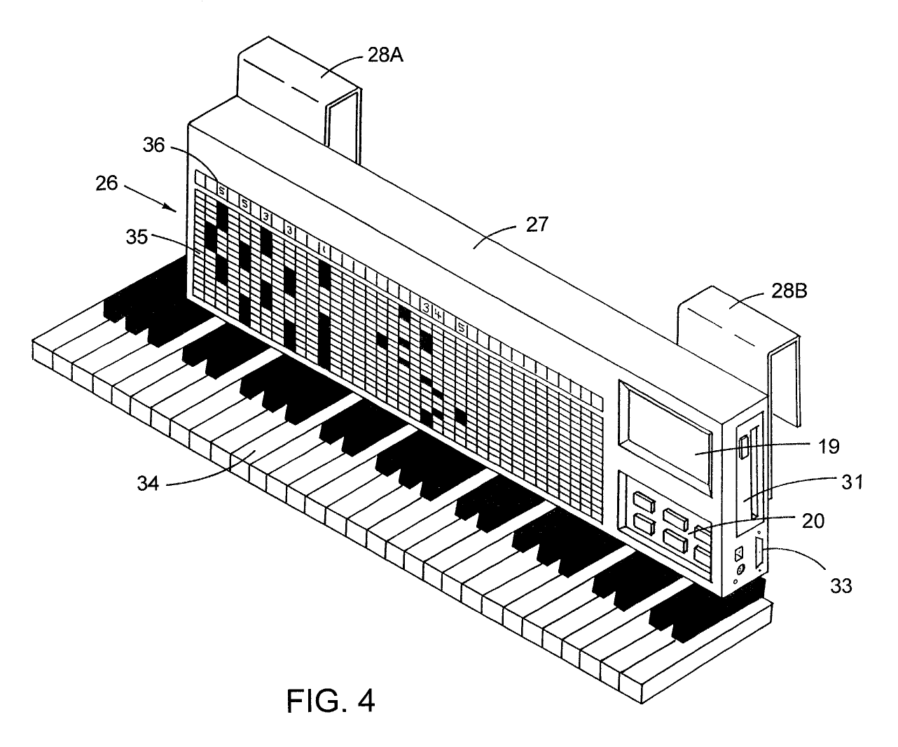

Referring next to FIG. 4 of the drawings, a housing 27 is arranged to enclose the components of FIG. 1 and, for a piano, has angles 28A and 28B to attach it to that instrument.

A floppy disc drive 31 is illustrated as one to receive a 3.5″ disc, which can of course be replaced by any other type of drive, such as a compact disk drive. Also, one or more suitable connectors 33 are available on the housing 27 through which other devices and the internet 15 are connected. Such devices include a PC 13, and/or a MIDI device 17.

The angles 28A and 28B attach the housing 27 to the piano so that it is supported in a selected position relative to the piano keys 34. A fingering and note display 26 includes a plurality of lights 35 and a single row of numeric displays 36. Groups of lights in the plurality of lights 35 are arranged in vertical rows immediately above each piano key.

When illuminated sequentially in accordance with a particular musical exercise, the user will be led to play a particular key at the particular time that the illuminated portion of a vertical row reaches the lowermost position in the vertical row.

Furthermore, the user will be able to anticipate the precise time at which this key must be played by virtue of the fact that the illuminated portion of the vertical row has been descending from an uppermost position in the vertical row to a lowermost position at a constant and predictable rate.

The user will be led further to sustain the note by holding this key down as long as the illuminated portion of the vertical row continues to descend to the lowermost position and only let up on the key when the last illuminated element disappears from the lowermost position of the vertical row which, again, can be anticipated as the trailing end of the illuminated portion also is descending at the same constant and predicable rate.

According to a presently preferred form of the invention, the vertical rows above white keys are of a different color from those above black keys to provide a clearer guidance to the student.

A series of numeric displays 36 is located across the top of the housing 27 to show the particular finger to use for that particular piano key in order to produce that particular musical note. These numeric displays 36 can be of a still different color to avoid confusion visually.

A user of the present invention can readily select a program, musical exercise, or function from the program menu 19 and control the selected activity by using the control panel 20.

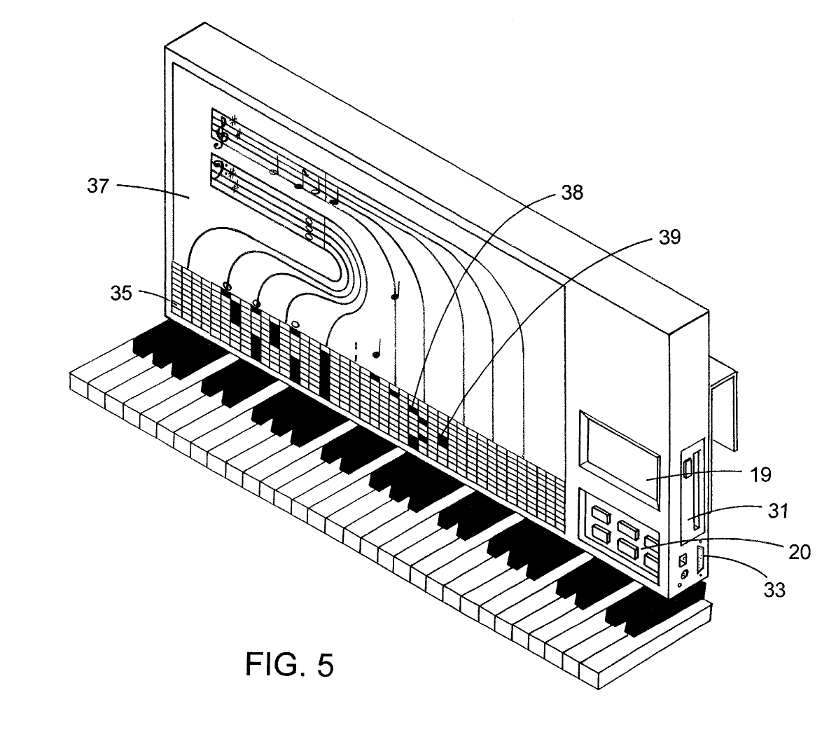

A modification of the invention is illustrated in FIG. 5 of the drawings for teaching an individual to read music. It has a series of lights that function similarly to those in FIG. 4 but, additionally, includes a display 37, which is a moving picture of a piece of music with notes moving to the right and downward, as indicated, as the music progresses.

When a note in the display 37 reaches a vertical row in the plurality of lights, it is converted to the timing and duration information necessary to represent in the way described previously. When an illuminated row of lights reaches a down-most position above a key, that key would be struck, and the key is held for a time indicated by the lit light above it.

For example, if that light is lit for one square only, the key is struck for a music tempo count of “one”; see musical note 38. The note 39 indicates a hold time of “two” in the music tempo.

The plurality of lights 35 is similar to those described in connection with FIG. 4. Moreover, the program menu 19 and the control panel 20 are like those described previously, as are the disc drive 31 and the connectors 33.

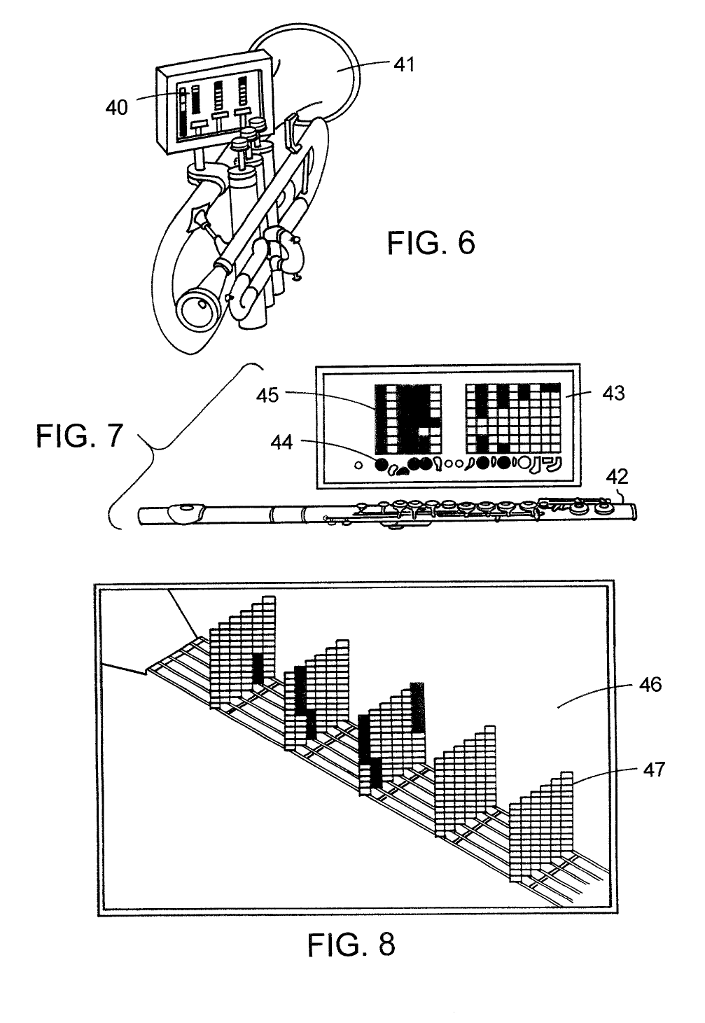

In FIG. 6 of the drawings, a modification of the present invention is illustrated for learning to play a horn.

Referring now to FIG. 6, a display 40 permits each valve of a horn 41 to be shown, and the display is located in a position that is best seen comfortably by the individual learning to play. The display 40 shows the valves with a plurality of lights arranged above each valve for use as described in connection with FIG. 4.

In FIG. 7 of the drawings, another modification of the present invention is illustrated for learning to play a flute 42. In this view, the flute keys 44 are shown on a display 43, and the plurality of lights 45 will function as described above.

The display 43 is located in a position that is convenient for the individual using the apparatus of the invention. It is located where there is little chance of interference with a user.

In FIG.8 of the drawings, a display 46 is illustrated to show a view of a stringed musical instrument with the plurality of lights 47 as they would appear to a user of the invention. The lights are located above each string in a position determined by notes to be played.

By placing a finger on a string as shown in the display 46 and by following the tempo indicated by the series of moving lights 47, an individual can be lead through a sheet of music and, with practice, can learn to play a stringed musical instrument in accordance with the present invention.

The plurality of lights 47 in this form of display 46 function according to the principles of the invention even though they are shown in a different array, i.e., arranged vertically above a perspective representation of the instrument. In this form, the lights are lit, first, at the top of the array and from that point, descend to the string.

The invention has been shown, described and illustrated in substantial detail with reference to presently preferred forms of the invention. It will be understood by those skilled in this art that various changes and modifications may be made without departing from the spirit and scope of the invention which is defined by the appended claims.

What is claimed is:

1. An apparatus for learning to play a selected piece of music with a predetermined tempo on a musical instrument having a keyboard with a plurality of keys, said apparatus comprising:
controller means for processing said selected piece of music according to said predetermined tempo of said music and for translating said selected piece of music into direct play data;
input means connected to said apparatus for entering said selected piece of music with said predetermined tempo to said controller;
display means having a plurality of columns adjacent said keyboard, with said columns in correspondence with and directly above each key of said keyboard; and
said display means having a connection to receive said direct play for data presenting a note activation sequence of said direct play data above each of said keys;
whereby said note activation sequence for said selected piece of music is displayed in correspondence with said keys and can be anticipated with minimum eye movement and without an ability to read music.

2. An apparatus for learning to play a selected piece of music, as defined by claim 1, wherein said display means is a flat panel for showing said direct play data.

3. An apparatus for learning to play a selected piece of music, as defined by claim 1, wherein said musical instrument is a piano.

4. An apparatus for learning to play a selected piece of music, as defined by claim 1, wherein said display means includes an array of light emitting elements.

5. An apparatus for learning to play a selected piece of music, as defined by claim 4, wherein said array of light emitting elements is arranged in a rectangular array.

6. An apparatus for learning to play a selected piece of music, as defined by claim 5, including housing means enclosing said controller with connections to a sound/tone generator means to produce audio prompts while learning to play said musical instrument.

7. An apparatus for learning to play a selected piece of music, as defined by claim 6, including means on said housing means for readily connecting detachably with said piano.

8. A system for learning to play a musical instrument, as defined by claim 7, wherein said detachable means on said housing means are adapted to support said housing means so that said array of light emitting elements are in vertical rows immediately above each key in said keyboard of said piano.

9. An apparatus for a user to learn to play a selected piece of music with a predetermined tempo on a musical instrument having a keyboard with a plurality of keys, said apparatus comprising:
housing means to enclose controller means with connections to receive a first and second inputs;
said first input arranged to enter tempo data to said controller;
said second input arranged to enter predetermined direct display data immediately above each keyboard key, and;
said housing means supporting an array of light emitting elements in vertical rows, each of which is immediately above and contiguous with one and only one of said plurality of keys, to be illuminated sequentially in accordance with said selected piece of music;
whereby said illumination sequence of lighting said plurality of light emitting elements permits said user to anticipate the initiation and duration of each note in said selected music without the ability to read-music and with minimum eye movement.

10. An apparatus for learning to play a selected piece of music, as defined by claim 9, wherein said musical instrument is a piano.
